(19) United States
(12) Patent Application Publication
(10) Pub. No.: US 2010/0052562 A1
(43) Pub. Date: Mar. 4, 2010

(54) Remote-Control Brightness Adjusting Device

(76) Inventor: Hui-Nan LIN, Kaohsiung City (TW)

Correspondence Address: Dr. BANGER SHIA, 102 Lindencrest Ct., Sugar Land, TX, 77479-5201, US

(21) Appl. No.: 12/201,080

(22) Filed: Aug. 29, 2008

(51) Int. Cl. H05B 41/36

(52) U.S. Cl. 315/291

(57) ABSTRACT

A remote-control brightness adjusting device comprises an emitter and a receiver. The emitter is provided with a switch circuit including a brightness switch and an on-off switch, and a signal emitting circuit. The receiver is provided with a signal receiving circuit, a converter, a brightness control circuit and an on-off control circuit. The emitter and the receiver utilize the signal emitting circuit and the signal receiving circuit to perform wireless transmission. When the brightness switch of the switch circuit is triggered, the change-over switch of the converter will be switched to utilize the brightness control circuit to adjust the brightness of the load. When the on-off switch of the switch circuit is triggered, the change-over switch of the converter will be switched to utilize the on-off control circuit to control the on-off of the load.

### BACKGROUND OF THE INVENTION

1. Field of the Invention

The present invention relates to an adjusting device, and more particularly to a remote-control brightness adjusting device.

2. Description of the Prior Art

Presently, lamps are normally controlled by means of switches, so that the user must go to the position where the switch is disposed to manually operate the switch, thus not only lacking of humanized design, but causing inconvenience in use.

The present invention has arisen to mitigate and/or obviate the afore-described disadvantages.

### SUMMARY OF THE INVENTION

The primary objective of the present invention is to provide a remote-control brightness adjusting device, which can remotely control the brightness.

In order to achieve the above objective, the remote-control brightness adjusting device of the present invention comprises an emitter and a receiver. The emitter is provided with a switch circuit including a brightness switch and an on-off switch, and a signal emitting circuit. The emitter is provided with a signal receiving circuit, a converter, a brightness control circuit and an on-off control circuit. The emitter and the receiver utilize the signal emitting circuit and the signal receiving circuit to perform wireless transmission. When the brightness switch of the switch circuit is triggered, the change-over switch of the converter will be switched to utilize the brightness circuit to adjust the brightness of the load. When the on-off switch of the switch circuit is triggered, the change-over switch of the converter will be switched to utilize the on-off control circuit to control the on-off of the load.

By such arrangements, the user can remotely adjust the brightness of the lamp, thus providing a humanized design and bringing more convenience in use.

### BRIEF DESCRIPTION OF THE DRAWINGS

FIG. 1 is a block diagram of a remote-control brightness adjusting device in accordance with the present invention; and

FIG. 2 is a block diagram of another remote-control brightness adjusting device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

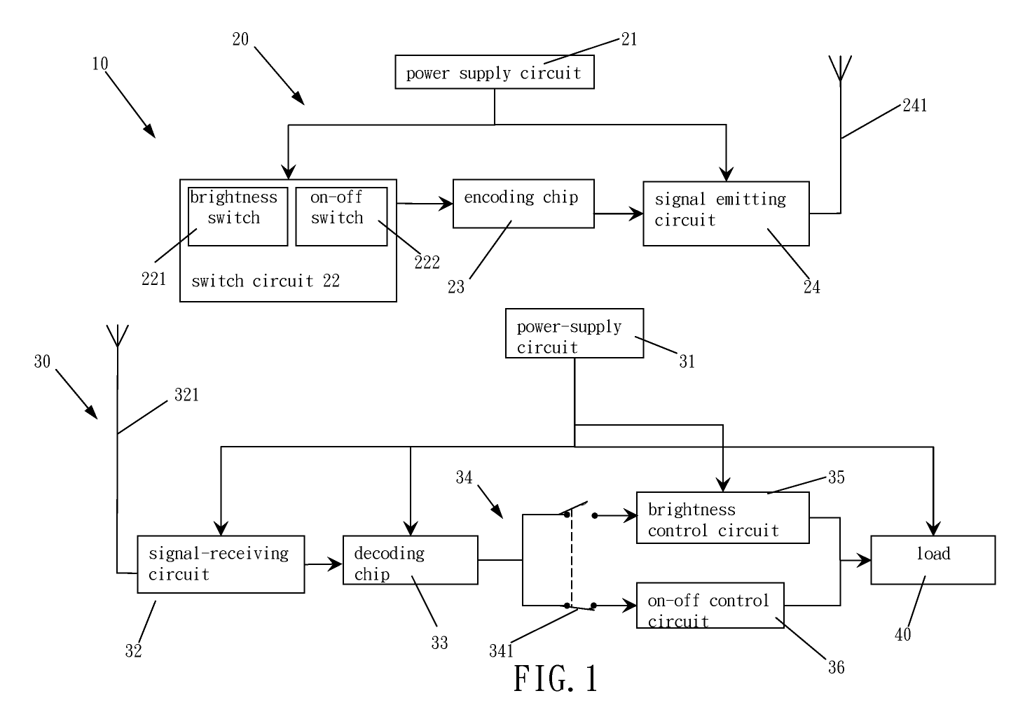

Referring to FIG. 1, a remote-control brightness adjusting device 10 in accordance with a preferred embodiment of the present invention comprises an emitter 20, a receiver 30 and a load 40.

The emitter 20 includes a power supply circuit 21, a switch circuit 22, an encoding chip 23 and a signal emitting circuit 24.

The power supply circuit 21 is connected with batteries for supplying power to the emitter 20.

The switch circuit 22 is provided with a brightness switch 221 and an on-off switch 222. The brightness switch 221 and the on-off switch 222 are in the form of a button, respectively. The brightness switch 221 controls the brightness signal to cooperate with the encoding chip 23. The on-off switch 222 controls the on-off signal to cooperate with the encoding chip 23.

The encoding chip 23 is electrically connected to the on-off circuit 22. The encoding chip 23 receives and then encodes the brightness signal from the brightness switch 221 and the on-off signal from the on-off switch 222, respectively.

The signal emitting circuit 24 is electrically connected to the encoding chip 23. The signal emitting circuit 24 includes an emitting antenna 241. The signal emitting circuit 24 performs amplitude shifting key modulation or frequency shifting key modulation to the encoded signal and emits the processed signal through the emitting antenna 241.

The receiver 30 includes a power-supply circuit 31, a signal-receiving circuit 32, a decoding chip 33, a converter 34, a brightness control circuit 35 and an on-off control circuit 36.

The power-supply circuit 31 is electrically connected to commercial power for supplying power to the emitter 20.

The signal receiving circuit 32 is a super-regenerative reception circuit or a super-heterodyne reception circuit and includes a receiving antenna 321. The signal receiving circuit 32 receives the encoded signal emitted from the emitter 20 through the receiving antenna 321 and then demodulates the received encoded signal.

The decoding chip 33 is electrically connected to the signal receiving circuit 32. The decoding chip 33 receives the demodulated signal for decoding the signal.

The converter 34 is electrically connected to the decoding chip 33. The converter 34 includes a change-over switch 341. The change-over switch 341 is a mechanical switch (a relay) or an electronic switch (a transistor). The change-over switch 341 of the converter 34 is used to switch the electrical connection of the decoding chip 33 to the brightness control circuit 35 or the on-ff control circuit 36.

The brightness control circuit 35 is electrically connected to the converter 34. When the brightness switch 221 of the switch circuit 22 of the emitter 20 is triggered, the change-over switch 341 of the converter 34 will be switched to make the decoding chip 33 electrically connect with the brightness control circuit 35 for outputting control signal.

The load 40 is a lamp and electrically connected to the brightness control circuit 35 and the on-off control circuit 36, respectively. When receiving the control signal, the brightness control circuit 35 will adjust the brightness of the load 40. When receiving the control signal, the on-off control circuit 36 will control the on-off of the load 40.

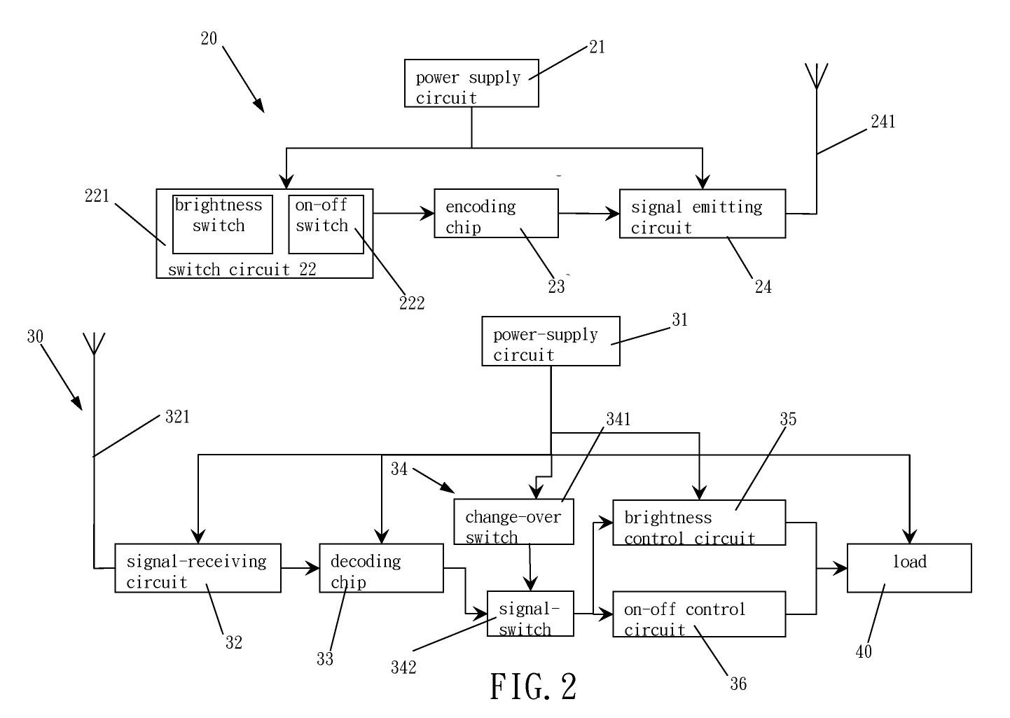

With reference to FIG. 2, the converter 34 is further provided with a single-chip 342, which is electrically connected with the change-over switch 341. When the decoded signal of the decoding chip 33 is guided into the single-chip 342 of the converter 34, the single-chip 342 utilizes its inner program to check if the brightness switch 221 or the on-off switch 222 of the switch control circuit 22 of the emitter 20 is triggered, so as to utilize the change-over switch 341 to control the corresponding brightness control circuit 35 or the on-off control circuit 36.

While we have shown and described various embodiments in accordance with the present invention, it is clear to those skilled in the art that further embodiments may be made without departing from the scope of the present invention.

What is claimed is:

1. A remote-control brightness adjusting device comprising:
an emitter being provided with a switch circuit including a brightness switch and an on-off switch, and a signal emitting circuit;
a receiver being provided with a signal receiving circuit, a converter, a brightness control circuit and an on-off control circuit, the signal emitting circuit of the emitter being in wireless connection with the signal receiving circuit of the receiver; and
a load being in electrical connection with the brightness control circuit and the on-off control circuit of the receiver; when the brightness switch of the switch circuit is triggered, a change-over switch of the converter will be switched to utilize the brightness control circuit to adjust brightness of the load, when the on-off switch of the switch circuit is triggered, the change-over switch of the converter will be switched to utilize the on-off control circuit to control on-off of the load.

2. The remote-control brightness adjusting device as claimed in claim 1, wherein:
the emitter is further provided with an encoding chip, which is electrically connected between the switch circuit and the signal emitting circuit, the encoding chip receives and then encodes a brightness signal of the brightness switch and an on-off signal of the on-off switch, respectively, the signal emitting circuit includes an emitting antenna, the signal emitting circuit modulates a received encoded signal and then emits it through the emitting antenna; and
the receiver includes a decoding chip, which is electrically connected to the signal receiving circuit, the decoding chip receives and then decodes a demodulated signal, the signal receiving circuit includes a receiving antenna, the signal receiving circuit utilizes the receiving antenna to receive the encoded signal from the emitter and then demodulate the received encoded signal, the converter is electrically connected to the decoding chip and includes the change-over switch, which is used to switch an electrical connection of the decoding chip to the brightness control circuit or the on-off control circuit.

3. The remote-control brightness adjusting device as claimed in claim 2, wherein the converter is further provided with a single-chip, which is electrically connected to the change-over switch of the converter, a decoded signal of the decoding chip is guided into the signal-chip of the converter, and then the converter utilizes its inner program to check if the brightness switch or the on-off switch of the switch circuit is triggered, so as to utilize the change-over switch of the converter to control the corresponding brightness control circuit or the on-off control circuit.

4. The remote-control brightness adjusting device as claimed in claim 2, wherein the signal emitting circuit performs amplitude shifting key modulation to the received encoded signal.

5. The remote-control brightness adjusting device as claimed in claim 2, wherein the signal emitting circuit performs frequency shifting key modulation to the received encoded signal.

6. The remote-control brightness adjusting device as claimed in claim 2, wherein the change-over switch of the converter is a mechanical switch.

7. The remote-control brightness adjusting device as claimed in claim 2, wherein the change-over switch of the converter is an electronic switch.

8. The remote-control brightness adjusting device as claimed in claim 2, wherein the load is a lamp.
